(19) United States
(12) Patent Application Publication
(10) Pub. No.: US 2013/0007104 A1
(43) Pub. Date: Jan. 3, 2013

(54) Time Zone Adjustment in User Interface

(76) Inventor: Pradeep Iyer, Cupertino, CA (US)

(21) Appl. No.: 13/194,661

(22) Filed: Jul. 29, 2011

Related U.S. Application Data
(60) Provisional application No. 61/503,459, filed on Jun. 30, 2011.

(51) Int. Cl. G06F 15/16

(52) U.S. Cl. 709/203

(57) ABSTRACT

Displaying time from a network device according to the time zone of the client. A network device keeps time to a first known time zone, such as UTC, and provides a web server. When a client device makes a request of the network device's webserver, the webserver returns an HTML document which includes code to extract the time zone offset from the client. This may be done for example using the javascript .getTime zone Offset( ) method, through the use of DLLs, or through other programming methods. The document also contains the time at the network device, which is displayed on the client device using the client time zone, and not using the clock or time information in the client device, only using the time zone offset in the client device.

### CROSS REFERENCE TO RELATED APPLICATIONS

This application claims the benefit of priority on U.S. Provisional Patent Application No. 61503459 filed Jun. 30, 2011 and entitled “Time Zone Adjustment in User Interface” (Attorney Docket No. 06259P128Z).

### BACKGROUND OF THE INVENTION

The present invention relates to digital networks, and more particularly, to the displaying the time from a remote network device in a client user interface using the client time zone.

Modern computers usually contain an on-board real time clock (RTC). In many systems this RTC comprises a reference crystal oscillator connected to a counter chain and is powered by a power source which usually includes a backup battery so that the RTC will continue in operation even when the device in which it is embedded is powered off or even disconnected from external power. Different implementations of RTCs may count time intervals since an epoch date in microseconds, milliseconds, or seconds, or may separate such a time value into more human-useable form, such as seconds, minutes, hours, day, month, and year.

The man who has one clock thinks he knows what time it is—the man who has two is never quite sure. Particularly given a network populated with devices each having its own RTC, what time is it? Of all the RTCs on the network, which one or ones are right?

This begs the question, in comparison to what? Protocols such as NTP (Network Time Protocol as defined in RFC 1305A) and SNTP (Simple Network Time Protocol) in conjunction with network-connected time standards allow this multitude of clocks to be disciplined and synchronized to a known standard. Typically, such systems rely on a common time standard such as Coordinated Universal Time (UTC) and local RTCs are kept synchronized to a UTC standard through periodic communications with one or more network time servers. Network time servers are available on the Internet for example at time.apple.com or nist1.symmetricom.com.

Using protocols such as SNTP and NTP and an NTP server, the real-time clocks in the various systems may be synchronized. This time is usually kept in a standard form, such as UTC. How do we display the time kept by the network device to clients, particularly when those clients may be in different time zones?

What is needed is a method of presenting the time kept by a network device to a client, using the client's time zone.

### BRIEF DESCRIPTION OF THE DRAWINGS

The invention may be best understood by referring to the following description and accompanying drawings that are used to illustrate embodiments of the invention in which:

FIG. 1 shows devices in a network.

### DETAILED DESCRIPTION

Embodiments of the invention relate to methods of displaying the time kept by a network device on a client user interface using the time zonetime zone of the client.

According to the present invention, when a client browser connects to a network device, the network device serves the client a web page which includes the network device time. This web page as executed by the client browser extracts the client time zonetime zone from the client system, and displays the time sent by the network device in the client user interface using the client time zonetime zone.

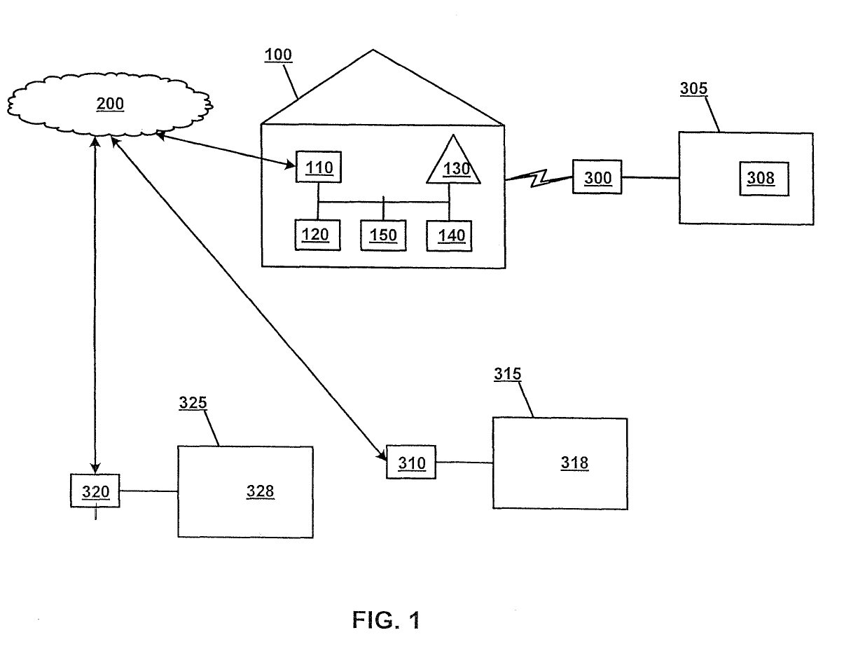

FIG. 1 shows a network in which network device 100 is a purpose-made digital device containing a processor 110, memory hierarchy 120, and input-output interfaces 130. In one embodiment of the invention, a MIPS-class processor such as those from Cavium or

RMI is used. Other suitable processors, such as those from Acorn, Intel, or AMD may also be used. The memory hierarchy 120 traditionally comprises fast read/write memory for holding processor data and instructions while operating, and nonvolatile memory such as EEPROM and/or Flash for storing files and system startup information. Wired interfaces 130 are typically IEEE 802.3 Ethernet interfaces, used for wired connections to other network devices such as switches, or to a controller. Wireless interfaces, such as those used in wireless access points are typically 802.11 interfaces. Network device 100 also contains a web server 140, which for example may be based on the well-known open-source Apache web server. Also included in network device 100 is real time clock (RTC) 150. In one embodiment of the invention, switch 100 operates under control of a LINUX operating system, with purpose-built programs providing network functionality in addition to the present invention.

Network device 100 typically communicates with clients 300, 310, 320, which are also digital devices having a processor, memory hierarchy, and commonly a plurality of interfaces, wired and/or wireless. A client device such as a laptop computer will usually contain a large LCD on which a user interface (UI) and/or graphical user interface (GUI) is provided. Client devices may also include desktop and handheld devices capable of operating a suitable browser coupled to a display.

As shown in FIG. 1, network device 100 communicates with network 200, and with client devices 300, 310, and 320. As shown in FIG. 1, client device 300 communicates locally and wirelessly with network device 100, where clients 310 and 320 communicate with network device 100 through network 200.

According to the present invention and as shown in FIG. 1, a client such as client 310 connects to network device 100 by causing a browser to open a connection to web server 140 in network device 100. The browser in client 310 may be any suitable browser such as Google Chrome, Mozilla Firefox, Apple Safari, Opera, or even Microsoft Internet Explorer.

When a client such as client 300 sends a request to web server 140 in network device 100, web server 140 returns a document in HTML format which is displayed as a web page in a window 305 on the display of client device 300.

According to the present invention, the document sent by web server 140 contains code to extract the time zonetime zone of client device 300. This process is known to the art and may be performed for example by including javascript code to invoke the .getTime zoneOffset( ) method. This time zone information may be bound to a local variable in the browser environment on client 300. The document sent by web server 140 also contains the time as kept by device 100 in a known time zone, preferably UTC with a time zone offset of zero. The client time zone information from client 300 is then used to display the time from network device 100 with the time zone of client 300 as an object 308 in window 305. Note that the time displayed as object 308 in window 305 is not related to the time kept by device 300 except through the use of the time zone.

When the web page is reloaded, which may be done automatically for example through the use of HTTP “Refresh” meta tag as known to the art, the time displayed as object 308 will be updated to show the current time at network device 100 in the time zone of client device 300. Note that object 308 may be a text string, a text field, or other object displaying the time.

Assume for example that network device 100 is located in Boston, which has a UTC offset of −5 hours. Assume client 300 is also in Boston, Mass. also with a time zone offset from UTC of −5 hours. Assume client 310 is located in Dallas, Tex. with a time zone offset from UTC of −6 hours. Further assume that client 320 is located in Sunnyvale, Calif. with a time zone offset from UTC of −8 hours.

If network device 100 receives a request from client 300 at 22:07 UTC on network device 100's clock, the time displayed in object 308 on client 300 will be network device 100's UTC time, 22:07, modified by the UTC offset of client device 300, which is −5 hours, resulting in a displayed time on object 308 of 17:07 local time, or 5:07 PM local time. The time according to client 300's clock is irrelevant.

If network device 100 receives a request from client 310 at 22:08 UTC on network device 100's clock, the time displayed in object 318 on client 310 will be network device 100's UTC time, 22:07, modified by the UTC offset of client device 310, which is −6 hours, resulting in a displayed time on object 318 of 16:08 local time, or 4:08 PM local time. The time according to client 310's clock is irrelevant.

If network device 100 receives a request from client 320 at 22:09 UTC on network device 100's clock, the time displayed in object 328 on client 320 will be network device 100's UTC time, 22:09, modified by the UTC offset of client device 320, which is −8 hours, resulting in a displayed time on object 328 of 14:09 local time, or 2:09 PM local time. The time according to client 320's clock is irrelevant.

In some embodiments, a client device receives a first time associated with standard time from the network device. This first time may be provided in a document such as a web page delivered on request from the client device by the network device, or the first time may be retrieved by the client device requesting the time from the network device. The client device next determines a time zone that is local to the first client device, and translates the first time into a second time, which corresponds to the time zone associated with the first client device. Then, the client device displays the second time to a user.

In some embodiments, the disclosed system further accepts a connection from a client browser to the network device, and serves a document to the client browser on the first client device, wherein the document comprises the message which is displayed according to the network device using the time zone associated with the first client device.

In some embodiments, the connection on the network device is made to a webserver running on the network device, the webserver serving the document to the client.

In some embodiments, the document contains the time according to the network device and code which when processed by the client browser extracts the time zone of the first client device and displays the time according to the network device using the time zone associated with the first client device.

In some embodiments, the time on the network device contained in the document is sent as Coordinated Universal Time (UTC) and the time zone associated with the first client device contains an offset from UTC.

In some embodiments, the disclosed system further determines a second time zone associated with a second client. The second time zone is different from the first time zone. Further, the disclosed system translates the first time into a third time, which corresponds to the time zone associated with the second client device. Then, the disclosed system displays a second message, which includes the third time, to the second client device.

In some embodiments, the network device is a controller or an access point, and the network device monitors or manages the first and second network devices.

It should be understood that the network device performing the steps and processes of the present invention may be a network switch, a network controller, an access point, a network server, or other network device. Similarly, the client device may be a laptop or desktop computer, tablet, handheld device, or fixed-function device capable of performing the methods described herein.

The present invention may be realized in hardware, software, or a combination of hardware and software. A typical combination of hardware and software may be a network server or access point with a computer program that, when being loaded and executed, controls aspects of the network device and the client device such that they carry out the methods described herein.

The present invention also may be embedded in nontransitory fashion in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

I claim:

1. A method of displaying the time from a network device on a client device comprising:
accepting the time from the network device in a standard time,
reading the timezone from the client device,
translating the time from the network device to a local time using the timezone from the client device, and
displaying the local time on the client device.

2. The method of claim 1 where the local time is displayed on the client device through a web page accessed by a web browser on the client device.

3. The method of claim 2 where the web page is served from the network device.

4. The method of claim 3 where the web page served from the network device contains the standard time from the network device.

5. The method of claim 3 where the web page served from the network device retrieves the standard time on the network device.

6. The method of claim 3 where the standard time on the network device is UTC and the timezone of the client device contains an offset from UTC.

7. A machine readable medium having a set of instructions stored in nonvolatile form therein, which when executed on a network device and a client device in communication with the network device causes a set of operations to be performed comprising:
accepting the time from the network device in a standard time,
reading the timezone from the client device,
translating the time from the network device in a standard time to a local time using the timezone from the client device, and
displaying the local time on the client device.
